(19) United States
(12) Patent Application Publication
(10) Pub. No.: US 2005/0034952 A1
(43) Pub. Date: Feb. 17, 2005

(54) Wet multi-plate clutch

(75) Inventors: Masahide Ogawa, Fukuroi-shi (JP); Hirofumi Nakagomi, Fukuroi-shi (JP); Yoshio Kinoshita, Fukuroi-shi (JP)

Correspondence Address: MILES & STOCKBRIDGE PC, 1751 PINNACLE DRIVE, SUITE 500, MCLEAN, VA, 22102-3833, US

(73) Assignee: NSK-Warner K.K.

(21) Appl. No.: 10/882,393

(22) Filed: Jul. 2, 2004

(30) Foreign Application Priority Data
Jul. 3, 2003 (JP) 2003-190742

(51) Int. Cl. F16D 25/0638

(52) U.S. Cl. 192/70.2; 192/85 AA

(57) ABSTRACT

In a wet multi-plate clutch in which an inner periphery of a clutch case is provided with a spline, and one of a friction engaging elements is fitted to the spline, the spline is provided with a recess whose sectional area is gradually increased toward an opened end of a clutch case.

### BACKGROUND OF THE INVENTION

1. Field of the Invention

The present invention relates to a wet multi-plate clutch used for an automatic transmission or the like, and more particularly, to an improvement of a clutch case of a wet multi-plate clutch.

2. Related Background Art

Generally, a wet multi-plate clutch has a clutch case having a substantially circular section. A hub is coaxially disposed on an inner periphery of the clutch case such that the hub relatively rotates. Separator plates engage with splines provided around an inner periphery of the clutch case. Friction plates and the separator plates are alternately disposed on the outer periphery of the hub in the axial direction. Friction materials are adhered to the friction plates. A piston pushes the separator plates and the friction plates to fasten them.

FIGS. 12 and 13 show a main portion of a conventional wet multi-plate clutch. FIG. 12 is an enlarged view of the main portion of a conventional clutch case as viewed from an opened end thereof, and FIG. 13 is a sectional view in the axial direction taken along a line 13-13 in FIG. 12. A clutch case 40 is provided at its inner periphery with a plurality of splines 41. A top surface of a crest projecting radially inward of each spline 41 is provided with a recess 42 which extends in the axial direction.

As shown in FIG. 13, a bottom surface of the recess 42 is in parallel to a clutch case outer cylindrical portion 43 and an axis of the clutch. Sectional shapes of the bottom surface of the recess 42 are the same in any portions thereof. Japanese Patent Application Laid-open No. 2001-336545 (U.S. Pat. No. 6,523,633) discloses one example of such techniques.

The above-explained recess 42 of the conventional wet multi-plate clutch is provided for enhancing the strength of the clutch case, and if the clutch case rotates, a portion of lubricant oil receives a centrifugal force and flows into the recess 42, but since the purpose of the recess 42 is not for enhancing the lubricity, the lubricity is not enhanced by the recess 42.

### SUMMARY OF THE INVENTION

It is an object of the present invention to provide a wet multi-plate clutch capable of enhancing the lubricity of the wet multi-plate clutch.

To achieve the above object, the invention provides a wet multi-plate clutch in which an inner periphery of a clutch case is provided with a spline and one of friction engaging elements is fitted to the spline, wherein the spline is provided with a recess whose sectional area is gradually increased toward an opened end of the clutch case.

In the invention, since the spline provided on the inner periphery of the clutch case, is provided with the recess whose sectional area is gradually increased toward the opened end of the clutch case, the lubricant oil which flowed into the recess tries to flow to a location where the pressure is reduced, i.e., a location where the sectional area is wider and thus, the lubricity of clutch is enhanced.

### BRIEF DESCRIPTION OF THE DRAWINGS

FIG. 1 is a front view of a wet multi-plate clutch of the present invention;

FIG. 2 is a sectional view of the clutch in its axial direction taken along a line 2-2 in FIG. 1;

FIG. 3 is an enlarged view of a main portion of a first embodiment of the invention;

FIG. 4 is an enlarged view of a main portion of a second embodiment of the invention;

FIG. 5 is an enlarged view of a main portion of a third embodiment of the invention;

FIG. 6 is a sectional view taken along a line 6A-6A in FIG. 3 or taken along a line 6B-6B in FIG. 5;

FIG. 7 is a sectional view of a main portion of a fourth embodiment of the invention;

FIG. 8 is a sectional view of a main portion of a fifth embodiment of the invention;

FIG. 9 is a sectional view of a main portion of a sixth embodiment of the invention;

FIG. 10 is a sectional view of a main portion of a seventh embodiment of the invention;

FIG. 11 is a sectional view taken along a line 11-11 in FIG. 10;

FIG. 12 is an enlarged view of a main portion of an opened end area of a conventional clutch case; and

FIG. 13 is a sectional view of the clutch case in its axial direction taken along a line 13-13 in FIG. 12.

### DETAILED DESCRIPTION OF THE PREFERRED EMBODIMENTS

Embodiments of the present invention will be explained in detail with reference to the accompanying drawings. In the drawings, the same elements are designated with the same symbols. The embodiments are for explaining the present invention, and it should be noted that the invention is not limited to the embodiments.

### First Embodiment

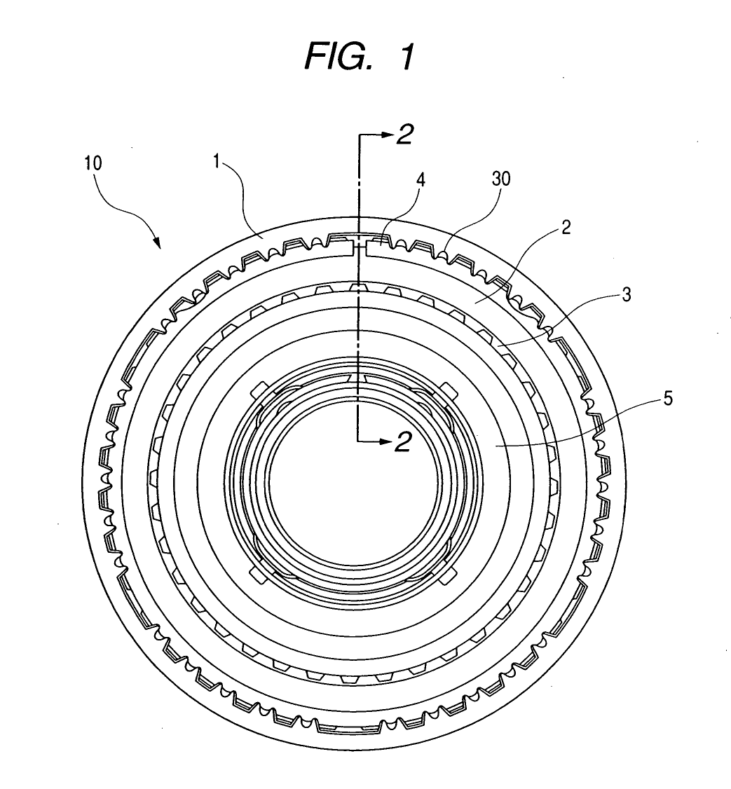

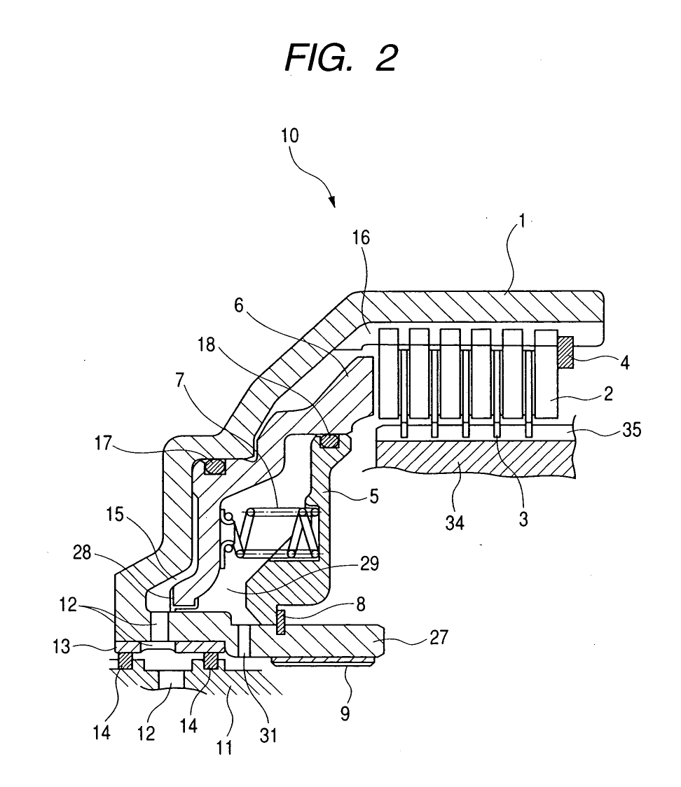

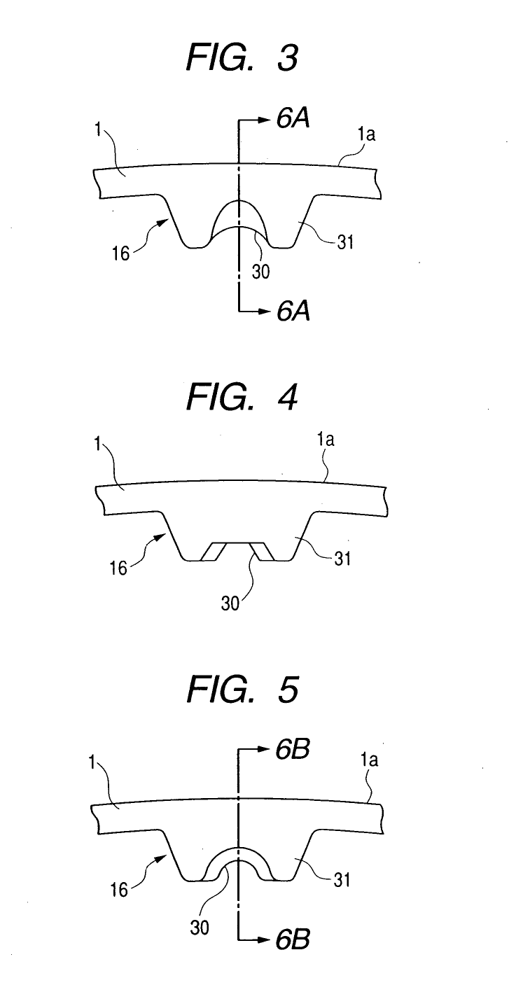

FIG. 1 is a front view of a wet multi-plate clutch according to the first embodiment of the present invention, FIG. 2 is a sectional view of the clutch in its axial direction taken along a line 2-2 in FIG. 1, and FIG. 3 is an enlarged view of a main portion of the first embodiment. A wet multi-plate clutch 10 includes a substantially cylindrical clutch case 1 whose one end in its axial direction is opened, a hub 34 which is disposed on an inner periphery of the clutch case 1 and which relatively rotates coaxially with clutch case 1, separator plates 2 which are disposed on the splines 16 provided on the inner periphery of the clutch case 1 such that the separator plates 2 can move in the axial direction, and friction plates 3 which are disposed on splines 35 provided on an outer periphery of the hub 34. The friction plates 3 and the separator plates 2 are alternately disposed in the axial direction. Friction materials are adhered to the friction plates 3.

The wet multi-plate clutch 10 includes a piston 6 which pushes the separator plates 2 and the friction plates 3 to fasten them. The clutch 10 also includes a detent ring 4 provided on the inner periphery of the clutch case 1 for fixing and holding the separator plates 2 and the friction plates 3 to one axial end of the detent ring 4.

A cylindrical portion 27 having a smaller diameter is integrally provided on the inner periphery of the clutch case 1. The cylindrical portion 27 extends in the axial direction. A slide bearing 9 is interposed between the cylindrical portion 27 and an output shaft 11. A sleeve 13 is interposed between the output shaft 11 and the cylindrical portion 27. A seal member 14 is disposed between the sleeve 13 and the output shaft 11 such as to sandwich a hydraulic pressure supply passage 12 therebetween.

As shown in FIG. 2, the piston 6 is disposed in the closed end of the clutch case 1 such that the piston 6 can slide in the axial direction. An O-ring 17 is interposed between the piston 6 and an inner surface of the clutch case. A seal member 28 is interposed between the piston 6 and an outer peripheral surface of the cylindrical portion 27. A hydraulic pressure chamber 15 is defined between the piston 6 and an inner surface of the closed end of the clutch case 1. The hydraulic pressure chamber 15 is maintained in its oil-tight state by the O-ring 17 and the seal member 28.

The output shaft 11 is provided with a hydraulic pressure supply passage 12. This passage 12 is defined by an opening of another hydraulic pressure supply passage connected to a hydraulic pressure source (not shown), an axial through hole of the sleeve 13 and an axial through hole of the cylindrical portion 27. A predetermined hydraulic pressure is supplied from the hydraulic pressure supply passage 12 to a hydraulic pressure chamber 15. The piston 6 faces the open end of the clutch case 1. An axial outer surface of the piston 6 is provided with a canceller 5 such that the canceller 5 can slide in the axial direction.

The canceller 5 is slidably supported at its radially inner periphery by an outer peripheral surface of the cylindrical portion 27. The canceller 5 is fixed to a detent ring 8 in the axial direction. The detent ring 8 is fitted to an outer periphery of the cylindrical portion 27. Therefore, the axially outward movement of the canceller 5 beyond a predetermined value is limited. An O-ring 18 is interposed between the piston 6 and the radially outer periphery of the canceller 5.

A second hydraulic pressure chamber 29 having a return spring 7 is interposed between the canceller 5 and the piston 6. The return spring 7 is interposed between the canceller 5 and the piston 6 and pushes back the piston 6. A hydraulic pressure supply hole 31 is formed in the cylindrical portion 27 such that the hydraulic pressure supply hole 31 passes therethrough in the radial direction. A hydraulic pressure is supplied to the hydraulic pressure chamber 29 from the hydraulic pressure supply hole 31.

The wet multi-plate clutch 10 having the above-described structure engages and disengages the clutch in the following manner. FIG. 2 shows the disengaged state of the clutch. In this state, the separator plates 2 and the friction plates 3 are separated from each other. In this disengaged state, the piston 6 is in abutment against the closed end of the clutch case 1 by a biasing force of the return spring 7 provided on the second hydraulic pressure chamber 29.

To engage the clutch in this state, the hydraulic pressure is supplied to the hydraulic pressure chamber 15 which is defined between the piston 6 and the clutch case 1. The piston 6 moves rightward in the axial direction in FIG. 2 against the biasing force of the return spring 7 provided on the second hydraulic pressure chamber 29, thereby bringing the separator plates 2 and the friction plates 3 into tight contact with each other. With this operation, the clutch is engaged.

To disengage the clutch, the hydraulic pressure of the hydraulic pressure chamber 15 is released. If the hydraulic pressure is released, the piston 6 moves to a position where the piston 6 abuts against the closed end of the clutch case 1 by the biasing force of the return spring 7. That is, the clutch is disengaged.

Next, the details of the first embodiment will be explained. The wet multi-plate clutch 1 explained with reference to FIGS. 1 and 2 has a structure to which all of embodiments of the present invention can be applied. As shown in FIG. 3, a recess 30 is provided in a crest 31 of each spline projecting radially inward of the spline 16 provided on the inner periphery of the clutch case 1. The depth of the recess 30 is gradually increased from the closed end of the clutch case 1 toward the opened end. That is, a bottom surface of the recess 30 on the side of the opened end approaches the outer peripheral surface 1a of the clutch case 1 as compared with the closed end. Therefore, the sectional area of the recess 30 in the radial direction is gradually increased and becomes the maximum at the opened end.

### Second Embodiment

FIG. 4 is an enlarged view of a main portion of a second embodiment of the invention. In the second embodiment, the width of the recess 30 is gradually increased from the closed end of the clutch case 1 toward the opened end. A distance between the bottom surface of the recess 30 and the outer peripheral surface 1a of the clutch case 1 from the closed end to the opened end of the clutch case 1 is not varied. Since the width is, wide at the opened end, the sectional area of the recess 30 in the radial direction is gradually increased and becomes the maximum at the opened end.

### Third Embodiment

FIG. 5 is an enlarged view of a main portion of a third embodiment of the invention. The third embodiment comprises a combination of the first and second embodiments. The depth of the recess 30 is gradually from the closed end toward the opened end of the clutch case 1. That is, the bottom surface of the recess 30 approaches the outer peripheral surface 1a of the clutch case 1 at the opened end as compared with the closed end.

The width of the recess 30 is gradually increased from the closed end of the clutch case 1 toward the opened end. Since both the depth and width become maximum at the opened end, the sectional area of the recess 30 in the radial direction is gradually increased and becomes the maximum at the opened end.

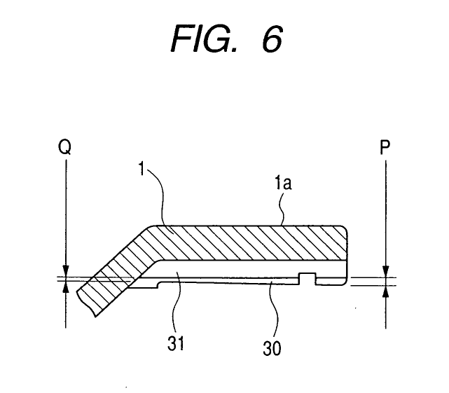

FIG. 6 is a sectional view taken along a line 6A-6A in FIG. 3 or taken along a line 6B-6B in FIG. 5. It can be seen that a distance P (on the side of the opened end) between the bottom surface of the recess 30 provided in the crest 31 of the spline 16 and the outer peripheral surface 1a of the clutch case 1 is greater than the distance Q (on the side of the closed end). That is, the depth of the recess 30 is shallower on the side of the closed end and deeper on the side of the opened end.

If the structure of any of the first to third embodiments is employed, when the clutch case 1 rotates, a portion of the lubricant oil receives a centrifugal force and flows into the recess 30 formed in the spline 16, and the lubricant oil which flowed into the recess 30 tries to flow to a location where the pressure is reduced, or tries to flow from a location where the centrifugal force acting on the lubricant oil is greater to a location where the centrifugal force is smaller, i.e., tries to flow out toward a location where the sectional area is wider. As a result, the lubricant oil efficiently flows from the closed end where the clutch of the clutch case 1 is provided to the opened end. It is preferable that the sectional area of the recess 30 becomes the maximum at the opened end, but since the purpose is to smoothen the flow of the lubricant oil, it is not always necessary that the sectional area becomes maximum at the opened end.

Next, fourth to seventh embodiments of the present invention will be explained. In these embodiments, the cross section shapes taken along the axial direction of the recess are the same, but the shapes are not especially limited, and the shape of the opened end shown in FIGS. 3 to 5 for example is also included.

### Fourth Embodiment

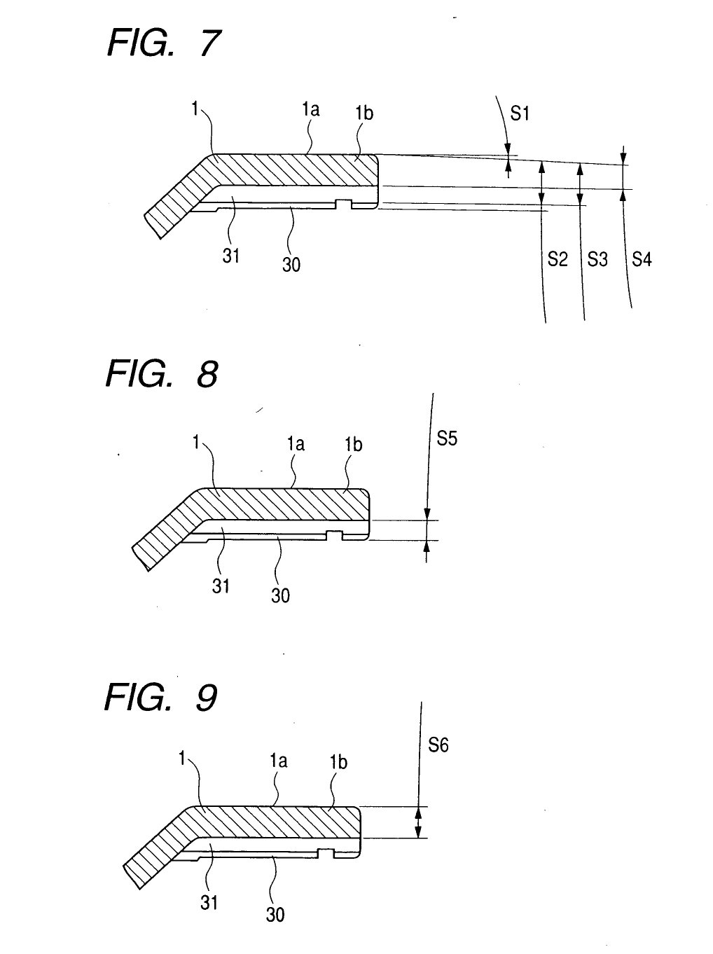

FIG. 7 is a sectional view of a main portion of a fourth embodiment of the invention. In the fourth embodiment, all of the recess 30, the crest 31 of the spline, the outer cylindrical portion 1b of the clutch case 1 and the outer peripheral surface 1a of the clutch case 1 are spread toward the opened end of the clutch case 1.

As shown in FIG. 7, the recess 30, the crest 31 of the spline, the outer cylindrical portion 1b and the outer peripheral surface 1a of the clutch case 1 are spread in the radial direction toward the opened end with respect to the axis of the clutch case 1.

### Fifth Embodiment

FIG. 8 is a sectional view in the axial direction of a main portion of a fifth embodiment of the invention. In the fifth embodiment, the height of the crest 31 of the spline is gradually lowered toward the opened end of the clutch case 1, and the recess 30 is provided in an upper surface of the crest 31 along a slope S5.

### Sixth Embodiment

FIG. 9 is a sectional view in the axial direction of a main portion of a sixth embodiment of the invention. In the sixth embodiment, the thickness of the outer cylindrical portion 1b of the clutch case 1 is reduced toward the opened end of the clutch case 1 so that the inner peripheral surface of the outer cylindrical portion 1b of the clutch case 1 is widened toward the opened end of the clutch case 1. The spline and the recess 30 are provided along this inner peripheral surface, and the recess 30 is gradually widened toward the opened end of the clutch case 1 in the outer diameter direction at a slope S6.

If the structure of any of the fourth to sixth embodiments is employed, when the clutch case 1 rotates, a portion of the lubricant oil receives a centrifugal force and flows into the recess 30 provided in the spline. The lubricant oil which flowed into the recess 30 receives an axial component of the centrifugal force by the slope of the bottom surface of the recess 30 and thus, the lubricant oil tries to flow out toward the opened end of the clutch case 1. As a result, the lubricant oil efficiently flows from the closed end where the clutch of the clutch case 1 is provided toward the opened end.

### Seventh Embodiment

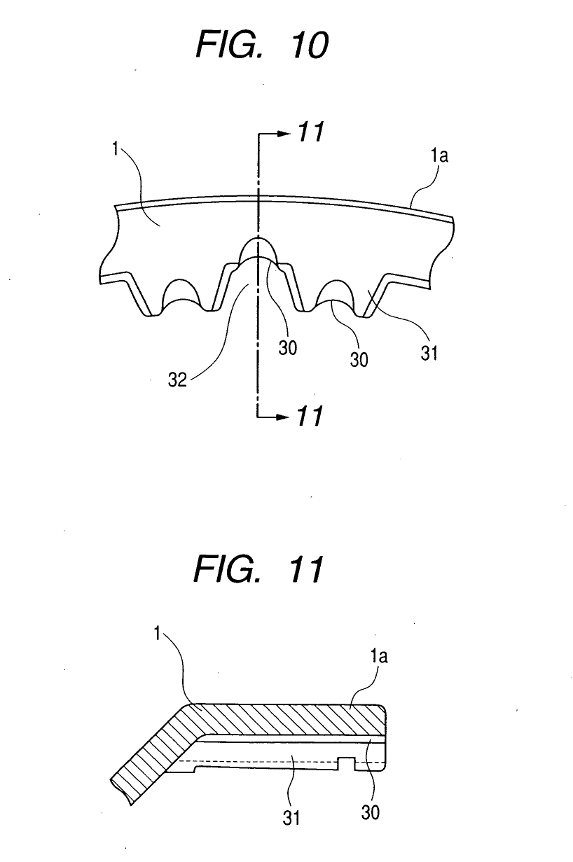

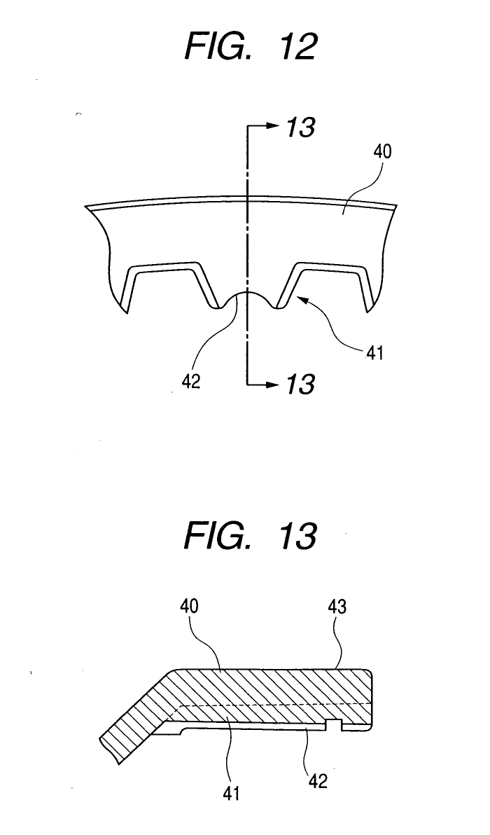

FIG. 10 is a sectional view of a main portion of a seventh embodiment of the invention. FIG. 11 is a sectional view taken along a line 11-11 in FIG. 10. In this embodiment, a valley 32 of the spline is also provided with the recess 30 which is explained in the previous embodiments. The recess 30 may be provided only in the valley 32 of the spline, but if the recesses 30 are provided in both the crest 31 and the valley 32 of the spline, the lubricity can further be enhanced.

According to the above-explained present invention, the following effects can be obtained.

That is, since the spline is provided with the recess whose sectional area is gradually increased toward the opened end of the clutch case or the spline is provided with the recess whose bottom surface is gradually inclined toward the opened end of the clutch case 1 in the outer diameter direction, the flow of the lubricant oil from inside to outside of the wet multi-plate clutch is smoothened, and lubricity of the wet multi-plate clutch can be enhanced. Therefore, the operation of the wet multi-plate clutch is smoothened and its lifetime is also increased.

At least one of the crest and valley of the spline is provided with the recess, but if both the crest and valley are provided with the recesses, the lubricity is further enhanced.

1. A wet multi-plate clutch in which an inner periphery of a clutch case is provided with a spline and one of friction engaging elements is fitted to the spline, wherein
the spline is provided with a recess whose sectional area is gradually increased toward an opened end of the clutch case.

2. The wet multi-plate clutch according to claim 1 in which an inner periphery of a clutch case is provided with a spline and one of friction engaging elements is fitted to the spline, wherein
the spline is provided with a recess whose bottom surface is gradually increased in an outer diameter direction toward an opened end of the clutch case.

3. The wet multi-plate clutch according to claim 2, wherein at least one of a crest and a valley of the spline is provided with the recess.
